(19) United States
(12) Patent Application Publication
(10) Pub. No.: US 2006/0086019 A1
(43) Pub. Date: Apr. 27, 2006

(54) Moving panel trading card

(76) Inventors: Wayne Wilcoxen, Carlsbad, CA (US); Martin Welling, Murrieta, CA (US)

Correspondence Address: The Law Office of Steven G. Roeder, 5560 Chelsea Avenue, La Jolla, CA, 92037, US

(21) Appl. No.: 10/970,037

(22) Filed: Oct. 21, 2004

(51) Int. Cl. G09F 7/00

(52) U.S. Cl. 40/491

(57) ABSTRACT

A collectible trading card (10) includes a card body (12) and a panel (14) that is movable relative to the card body (12) when the card body (12) is tilted. The card body (12) includes a first card image (26) and a second card image (28), and the panel (14) includes a panel image (42). The panel (14) is movable between a first position (38) in which the panel (14) covers the first card image (26), and a second position (40) in which the panel (14) covers the second card image (28). With this design, in the first position (38), the second card image (28) and the panel image (42) are visible. Alternatively, in the second position (40), the first card image (26) and the panel image (42) are visible.

### BACKGROUND

Trading cards are a popular way to collect images and information about athletes and celebrities. Unfortunately, many of the trading cards are manufactured in large quantities and are not very unique. Further, existing trading cards may not provide enough surface area for multiple images of the athlete or celebrity.

### SUMMARY

The present invention is directed to a trading card that includes a card body and a panel that is movable relative to the card body when the card body is tilted. In one embodiment, the card body includes a first card image and a second card image, and the panel includes a panel image. In one embodiment, the panel is movable between a first position in which the panel covers the first card image, and a second position in which the panel covers the second card image. With this design, in the first position, the second card image and panel image are visible. Alternatively, in the second position, the first card image and panel image are visible.

In one embodiment, the panel slides back and forth relative to the card body between the first position and the second position. In one design, the card body includes a slot and a viewing region that covers the slot. Further, the first and second images are positioned side-by-side on the back of the slot. Further, the panel fits into the slot and moves back and forth within the slot when the card body is tilted.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a first perspective view of a trading card having features of the present invention with the trading card tilted in a first orientation;

FIG. 2 is a second perspective view of the trading card of FIG. 1 with the trading card tilted in a second orientation;

FIG. 3 is an exploded perspective view of the trading card of FIG. 1; and

FIGS. 4A and 4B are alternative perspective views of another embodiment of a trading card.

### DESCRIPTION

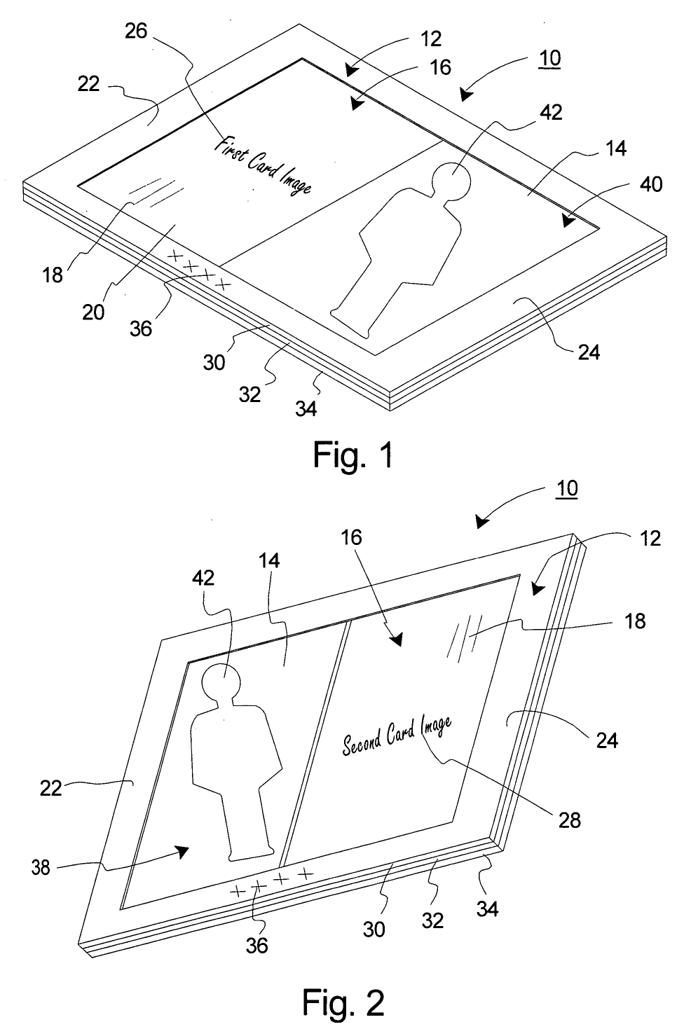

FIGS. 1 and 2 are perspective views of a trading card 10 in alternative positions, having features of the present invention. The trading card 10 includes a card body 12 and a panel 14 that is coupled to and movable relative to the card body 12. The size and shape of these components can be varied to suit the desired design requirements of the trading card 10.

In one embodiment, the trading card 10 is generally flat, rectangular shaped and has a length of between 2 and 6 inches, a width of between approximately 1.5 and 4.0 inches, and a thickness of between approximately 0.0625 and 0.25 inches. For example, the trading card 10 can be a standard trading card having a length of approximately 3.5 inches, a width of approximately 2.5 inches, and a thickness of between approximately 0.0625 and 0.1875 inches.

The card body 12 retains the panel 14, encloses the panel 14, and allows the panel 14 to move. In one embodiment, the card body 12 defines a slot 16 and includes a viewing region 18 that covers at least a portion of the slot 16. The slot 16 is sized and shaped to receive the panel 14 and allow the panel 14 to easily move back and forth in the slot 16. In the embodiment illustrated in FIGS. 1 and 2, the slot 16 is generally rectangular shaped and slightly larger than the panel 14 so that the panel 14 can move easily within the slot 16. The viewing region 18 exposes a portion of the panel 14 and a portion of a back 20 of the slot 16. In the embodiment, illustrated in FIGS. 1 and 2, the viewing region 18 is generally rectangular shaped. Alternatively, for example, the viewing region 18 can have another shape, such as oval, circular, or octagonal shaped.

Additionally, the card body 12 can include one or more images. For example, in the embodiment illustrated in FIGS. 1 and 2, the card body 12 includes a first card image 26 and a second card image 28 that has been transferred to the slot 16 of the card body 12. In this embodiment, the card images 26, 28 are positioned substantially side-by-side on the back 20 of the slot 16. Alternatively, the card body 12 can include more than two or less than two card images. As non-exclusive examples, one or each card image 26, 28 can be that of a sports athlete, a celebrity, an entertainer, statistics, a team logo, a game field or arena, an image used in a game, an animated character, an autograph, an animal or landscape. Each card image 26, 28 can be related in some fashion. For example, each card image 26, 28 can be of the same individual or character or can be on the same team or the same size. Still alternatively, one of the card images 26, 28 can be an individual and the other card image 28, 26 a team logo for the team that the individual plays for.

Further, the card body 12 includes a left edge 22 and an opposed right edge 24. Moreover, in FIGS. 1 and 2, the card body 12 includes a first body section 30, a second body section 32, and a third body section 34 and the panel 14 is positioned between and fully enclosed within the body sections 30, 32, 34 at all times. Alternatively, for example, one or more of the sections 30, 32, 34 can be integrated together, laminated, or glued together.

In one embodiment, the card body 12 includes card information 36 relating to and/or explaining the card images 26, 28, operation of the trading card 10, and/or the company that manufactures or distributes the trading card 10.

The panel 14 is coupled to the card body 12 and moves relative to the card body 12. In one embodiment, the panel 14 moves between a first position 38 (illustrated in FIG. 2) and a second position 40 (illustrated in FIG. 1). Additionally, in one embodiment, the panel 14 includes a panel image 42. As non-exclusive examples, the panel image 42 can be that of a sports athlete, a celebrity, an entertainer, statistics, a team logo, a game field or arena, an image used in a game, an animated character, an autograph, an animal or landscape The panel image 42 can be related in some fashion to one or all of the card images 26, 28. For example, the panel image 42 can be of the same individual or character or can be on the same team as the card images 26, 28.

In one embodiment, (i) when the card body 12 is tilted so that the left edge 22 is higher than the right edge 24, the panel 14 moves from the first position 38 to the second position 40, and (ii) when the card body 12 is tilted so that the right edge 24 is higher than the left edge 22, the panel 14 moves from the second position 40 to the first position 38. The amount of tilt of the card body 12 required to cause movement between the positions 38, 40 can vary. In alternative, non-exclusive embodiments, the panel 14 moves when the card body 12 is tilted at least approximately 20, 30, 40, 50, 60, 70, 80 or 90 degrees. Further, in one embodiment, the panel 14 is moved between positions 38, 40 without physically touching the panel 14.

In FIGS. 1 and 2, (i) when the panel 14 is in the first position 38, the panel 14 covers the first card image 26, and the second card image 28 and the panel image 42 are visible through the viewing region 18, and (ii) when the panel 14 is in the second position 40, the panel 14 covers the second card image 28, and the first card image 26 and the panel image 42 are visible through the viewing region 18. Stated another way, the panel 14 simultaneously hides one card image 26, 28 and reveals one card image 26, 28. In FIGS. 1 and 2, the panel 14 is positioned in the slot 16 between the back 20 and the viewing region 18.

With this design, in certain embodiments, the trading card 10 is a unique, collectible trading card that includes three images 26, 28, 42. Further, the trading card 10 provides more surface area for printing.

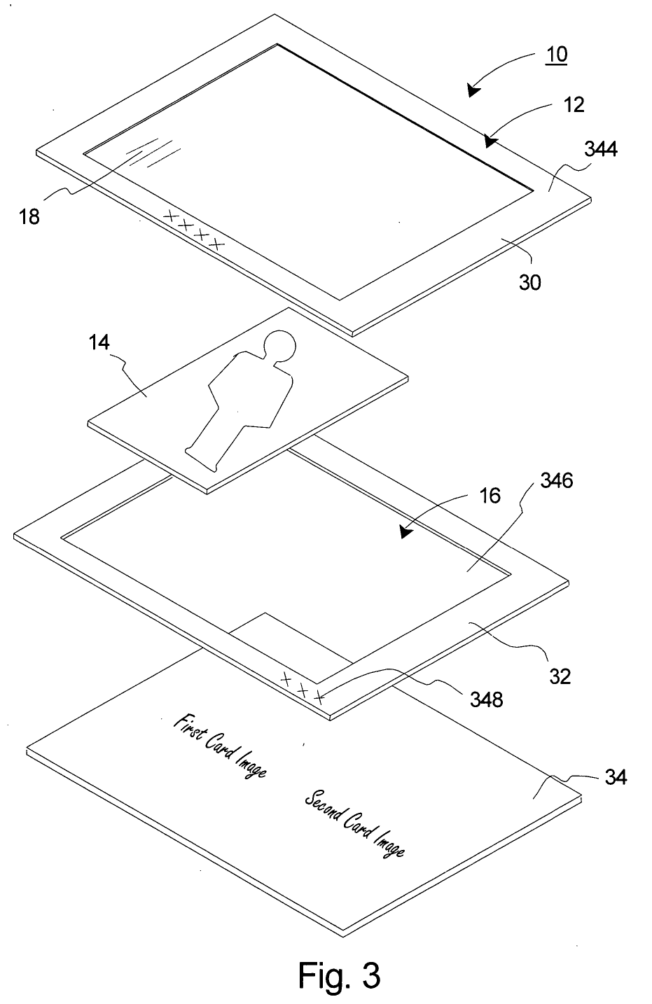

FIG. 3 is an exploded perspective view of the trading card 10, including the panel 14, and the body sections 30, 32, 34 of the card body 12. In one embodiment, the panel 14, and the second and third body sections 32, 34 are each made of card stock. In one embodiment, the panel 14 is thinner than the second body section 32. In alternative, non-exclusive examples, the panel 14 is approximately 10, 20, 30, 40, 50, or 60% thinner than the second body section 32. With this design, the panel 14 can easily slide in the slot 16 with minimal resistance. For example, the second body section 32 and the third body section 34 can be made of 24 points card stock and the panel 14 can be made of 12 points card stock.

In FIG. 3, the panel 14 is generally flat, rectangular plate shaped. In one embodiment, the panel 14 has a length of between approximately 1.5 and 2 inches, and a width of between approximately 1.25 and 1.75 inches.

Further, in FIG. 3, each body section 30, 32, 34 is generally flat, rectangular plate shaped. In one embodiment, the first body section 30 includes a viewing aperture 344. As an example, the first body section 30 can be made of a solid, substantially transparent material, e.g. PVC or other clear plastic. Further, the border or edges of the first body section 30 can include printing 344 so as to define a centrally located and rectangular shaped viewing region 18. The printing 344 can also hide the second body section 32 and the gap between the second body section 32 and the panel 14 when viewed from the top of the trading card. The printing 344 along the border can include colors, characters, numbers, and/or other designs. Alternatively, an aperture (not shown) can be die-cut from a piece of card stock and a piece of substantially transparent material can be placed in the aperture to form the first body section 30.

The second body section 32 includes a panel aperture 346 that is sized and shaped to sliding receive the panel 14 and define the slot 16. In one embodiment, the slot 16 is larger than the panel 14. The viewing region 18 and the third body section 34 should be sufficiently rigid to inhibit bowing of the viewing region 18 and the third body section 34 that can restrict movement of the panel 14. In should be noted that information regarding the manufacturer or the images can be displayed on the back side (not shown) of the third body section 34.

In one embodiment, a section retainer 348 secures the body sections 30, 32, 34 together. For example, the section retainer 348 can be an adhesive. Alternatively, the body sections 30, 32, 34 can be laminated together.

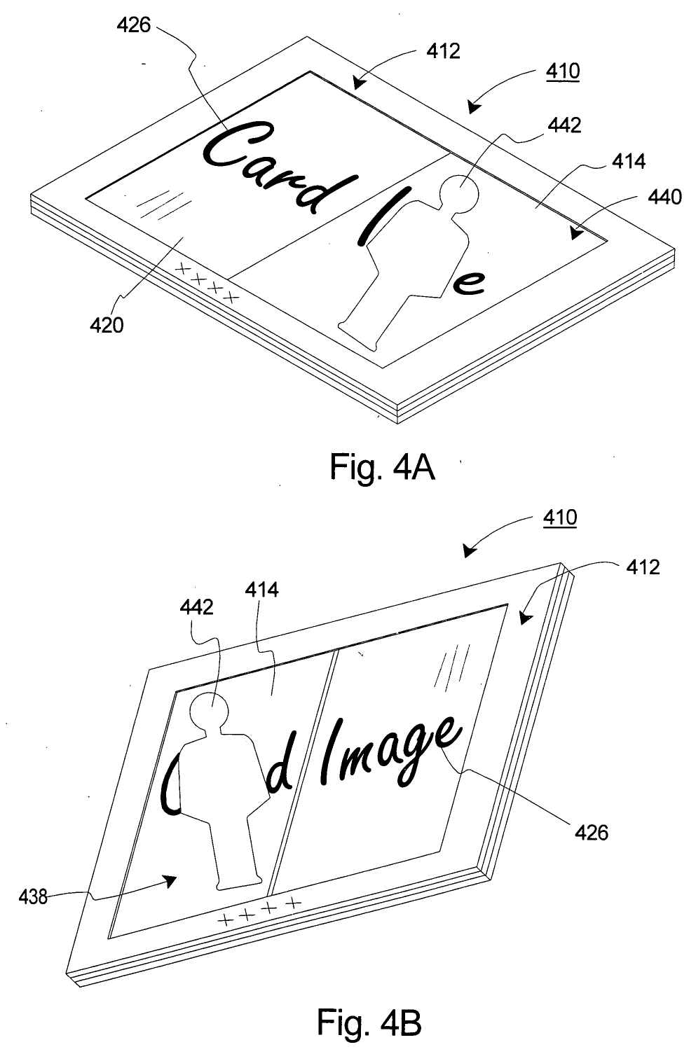

FIGS. 4A and 4B are perspective views of another embodiment of a trading card 410 in alternative positions, having features of the present invention. The trading card 410 includes a card body 412 and a panel 414 that are somewhat similar to the corresponding components described above. For example, the card body 412 can again include one or more images, and the panel 414 can include the panel image 442. Further, the panel 414 can move between the first position 438 (illustrated in FIG. 4B) and the second position 440 (illustrated in FIG. 4A).

However, as illustrated in FIGS. 4A and 4B, the card body 412 includes a single card image 426 that covers the entire back of the slot 420. Further, in this embodiment, the panel 414 includes a panel image 442 and the panel 414 is at least partly substantially transparent. With this design, at least a portion of the card image 426 is visible through the panel 414. Further, in one embodiment, the panel image 442 covers a portion of the card image 426.

In one embodiment, the card image 426 can be that of a playing field or playing area and the panel image 442 can be that of a player. With this design, when the trading card 410 is tilted and the panel 414 moves relative to the card body 412, the trading card 410 can simulate the movement of the player across the playing field or playing area.

As a non-exclusive example, the playing area can be an ice ring and the player can be a hockey player. With this design, tilting of the trading card 410 results it the hockey player moving along the ice. As another example, the playing area can be a football field and the player can be a football player. With this design, tilting of the trading card 410 results in the football player moving along the football field.

It is to be understood that the trading cards 10 disclosed herein is merely illustrative of the presently preferred embodiments of the invention and that no limitations are intended to the details of construction or design herein shown other than as described in the appended claims.

What is claimed is:

1. A trading card comprising:
a card body that includes a first card image; and
a panel that is coupled to and moves relative to the card body when the card body is tilted, the panel including a panel image.

2. The trading card of claim 1 wherein the card body includes a second card image.

3. The trading card of claim 2 wherein the panel is movable between a first position in which the panel covers the first card image, and a second position in which the panel covers the second card image.

4. The trading card of claim 3 wherein when the panel is in the first position, the second card image and the panel image are visible and when the panel is in the second position, the first card image and the panel image are visible.

5. The trading card of claim 3 wherein the panel slides back and forth relative to the card body between the first position and the second position.

6. The trading card of claim 1 wherein the panel slides back and forth relative to the card body between a first position and a second position and the panel is enclosed within the card body.

7. The trading card of claim 6 wherein the card body includes a slot and the panel slides back and forth in the slot when the card body is tilted.

8. The trading card of claim 7 wherein the card body includes a second card image and the card images are positioned side-by-side on a back of the slot.

9. The trading card of claim 7 further comprising a viewing region that covers the slot and the panel.

10. The trading card of claim 1 wherein at least a portion of the panel is substantially transparent and at least a portion of the first card image is viewable through the panel.

11. A trading card comprising:
a card body that includes a first card image and a second card image; and
a panel that is coupled to and moves relative to the card body between a first position and a second position, the panel including a panel image, in the first position the second card image and the panel image are visible and in the second position the first card image and the panel image are visible.

12. The trading card of claim 11 wherein the card body panel moves between from one position to the other position when the card body is tilted.

13. The trading card of claim 11 wherein in the first position the panel covers the first card image, and in the second position the panel covers the second card image.

14. The trading card of claim 11 wherein the panel slides back and forth relative to the card body between the first position and the second position and the panel is enclosed within the card body.

15. The trading card of claim 11 wherein the card body includes a slot and the panel slides back and forth in the slot.

16. The trading card of claim 15 wherein the card images are positioned substantially side-by-side on a back of the slot.

17. The trading card of claim 16 further comprising a viewing region that covers the slot and the panel.

18. A trading card comprising:
a card body that includes a first card image and a second card image that are positioned side by side; and
a panel that is enclosed within and moves relative to the card body between a first position and a second position when the card body is tilted, the panel including a panel image, in the first position the panel covers the first card image, and the second card image and the panel image are visible, and in the second position the panel covers the second card image and the first card image and the panel image are visible.

19. The trading card of claim 18 wherein the card body includes a slot and the panel slides back and forth in the slot relative to the card body between the first position and the second position.

20. The trading card of claim 19 further comprising a viewing region that substantially covers the slot and the panel.
